(19) United States
(12) Patent Application Publication
(10) Pub. No.: US 2023/0286180 A1
(43) Pub. Date: Sep. 14, 2023

(54) RETRACTABLE BLADE AND ADJUSTABLE GUARD KNIFE CONCEPT

(71) Applicant: Allen Elishewitz, New Braunfels, TX (US)

(72) Inventor: Allen Elishewitz, New Braunfels, TX (US)

(21) Appl. No.: 18/106,709

(22) Filed: Feb. 7, 2023

Related U.S. Application Data
(60) Provisional application No. 63/318,412, filed on Mar. 10, 2022.

(51) Int. Cl. B26B 1/08; B26B 1/10

(52) U.S. Cl. CPC B26B 1/08; B26B 1/10

(57) ABSTRACT

A knife comprises an elongated frame defining a blade passage and having a forward opening at one end of the frame. An elongated blade is received in the frame and movable between an extended and a retracted position; and the blade has a point at a first end and having a first blade portion extending from the frame when the blade is in the retracted position and a greater end position extended from the frame when the blade is in the extended position.

### CROSS-REFERENCE TO RELATED APPLICATIONS

This application claims the benefit of U.S. Provisional Patent Application No. 63/318,412, filed on Mar. 10, 2022, entitled “RETRACTABLE BLADE AND ADJUSTABLE GUARD KNIFE CONCEPT”, which is hereby incorporated by reference in its entirety for all that is taught and disclosed therein.

### FIELD OF THE INVENTION

The present invention relates to retractable blade knives.

### BACKGROUND AND SUMMARY

It can be difficult to have two fixed blades in different sizes for the same knife.

Often, the user's hand can slip while the knife is in use, causing injury.

The above disadvantages are addressed by a knife comprised of an elongated frame defining a blade passage and having a forward opening at one end of the frame. An elongated blade is received in the frame and movable between an extended and a retracted position; and the blade has a point at a first end and having a first blade portion extending from the frame when the blade is in the retracted position and a greater end position extended from the frame when the blade is in the extended position.

### BRIEF DESCRIPTION OF THE DRAWINGS

FIG. 1A to FIG. 1E illustrates a Blade extended;

FIG. 2A to 2D illustrates a Blade retracted;

FIG. 3A to 3F illustrates a Frame only with handle and ring;

FIG. 4A to 4G illustrates a Front and back handle and ring;

FIG. 5A to 5F illustrates a Blade, locking bar and interface; and

FIG. 6 illustrates an Exploded view.

### DETAILED DESCRIPTION OF A PREFERRED EMBODIMENT

This concept allows a user to have a fixed blade in two different blade lengths. If the user needs a short blade, the blade is in the retracted position. If the user needs a longer blade, he uses it in the extended position. The blade slides into the handle and is supported by the internal rails in the frame. This is not a gravity knife because a gravity knife conceals the blade entirely in the retracted position.

This knife also features a ring that acts as a guard to prevent the hand from slipping while in use. The ring/guard is adjustable and can be located in several different positions on the handle (horizontally or vertically) via rails. Or if the user does not want the ring/guard, it can be removed completely. I am saying ring/guard to be more broad with what is being attached there.

The concept of the blade retracting in the handle and part of it exposed is not a new concept. I invented this about 17 years ago for MOD called the Phoenix. Back then we used a button lock to hold the blade in the extended position. This tuning fork style lock, which is essentially a liner lock that only makes contact in 2 spots leaving the center untouched, is a far superior locking mechanism for this knife because it creates 3 points of contact. I am wondering if this retractable blade tuning lock can be protected even though the retractable blade idea is prior art. So my main focus in the patent would be two folds: utilizing this lock with the retractable blade and a ring/guard that can be located vertically or horizontally on the handle.

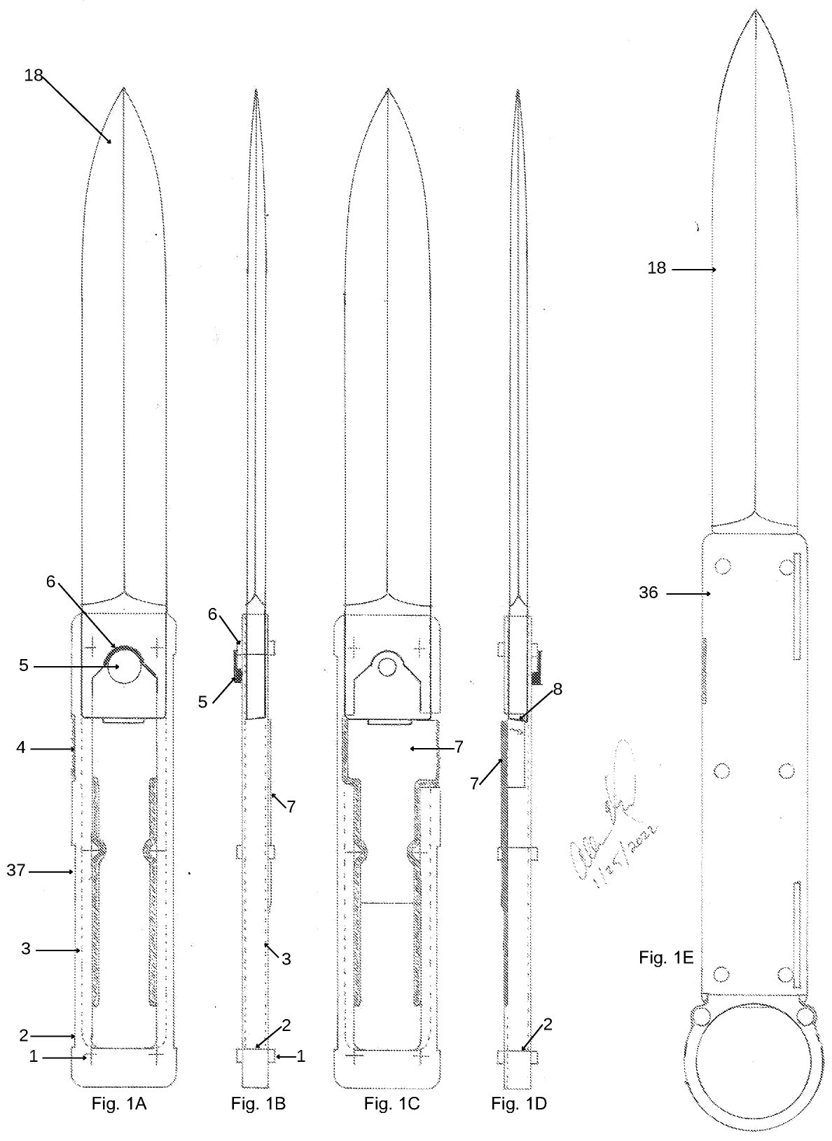

Referring to FIG. 1A to FIG. 1E—Blade extended. The elements include 1. Taped holes to hold the handle material to the main frame 2. Countersunk for skateboard tape 3. Internal track for blade 4. Serrations on locking mechanism for traction 5. Stop pin—This stops the blade in the extended and retracted positions 6. Bas relief to add more material to support the stop pin 7. Locking bar—Two third of the locking bar is thicker than the one third which tapers. The thinner portion of the locking bar allows it to be a spring and bend inwards. The face of the locking bar has a gap in the center producing a 2 point contact on either end of the blade. The center of the blade does not make contact with the locking bar. 8. Taper on the blade—Allows the locking bar to wedge up and keep the blade in the extended position 9. Blade 10. Front handle 11. Frame.

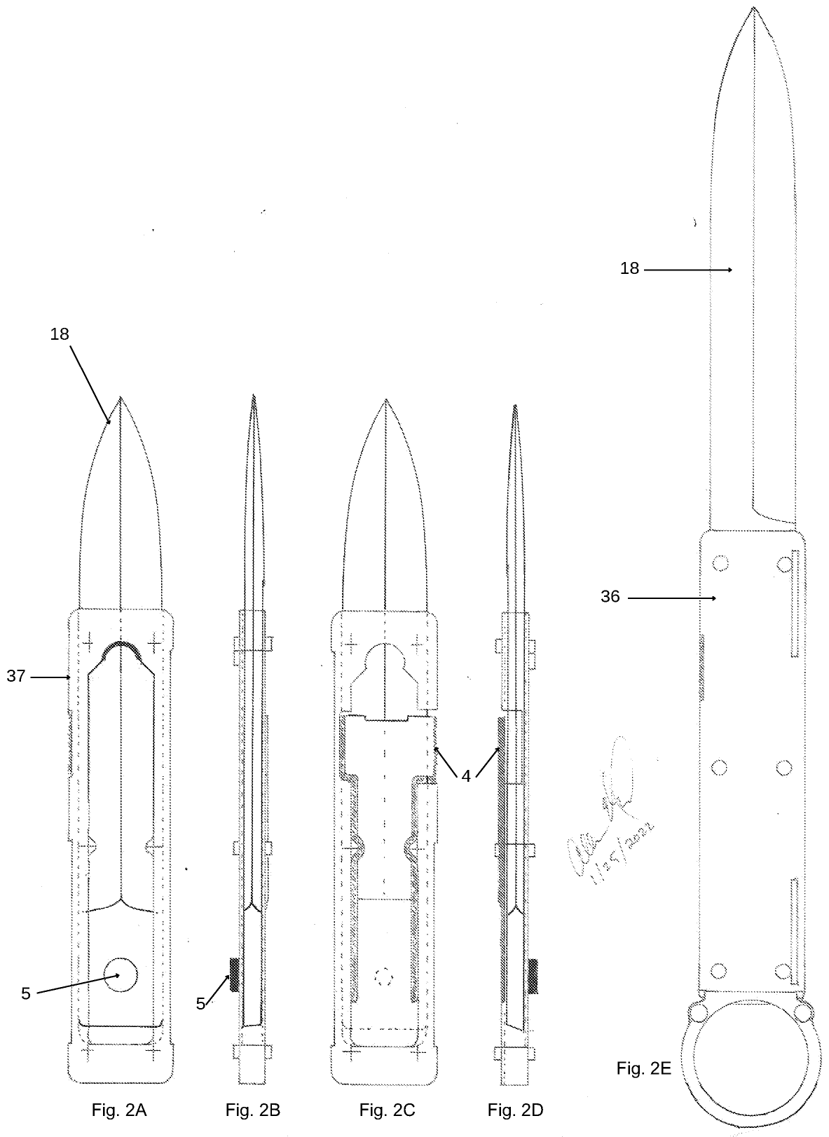

Referring to FIGS. 2A to 2D—Blade retracted The elements include 4. The exposed serrations allow the user to push the locking bar (#7) to the side to retract the blade in the handle. There will always be a portion of the blade extended out of the handle 5. Stop pin in the retracted position. 1. Blade 2. Front handle and 3. Frame.

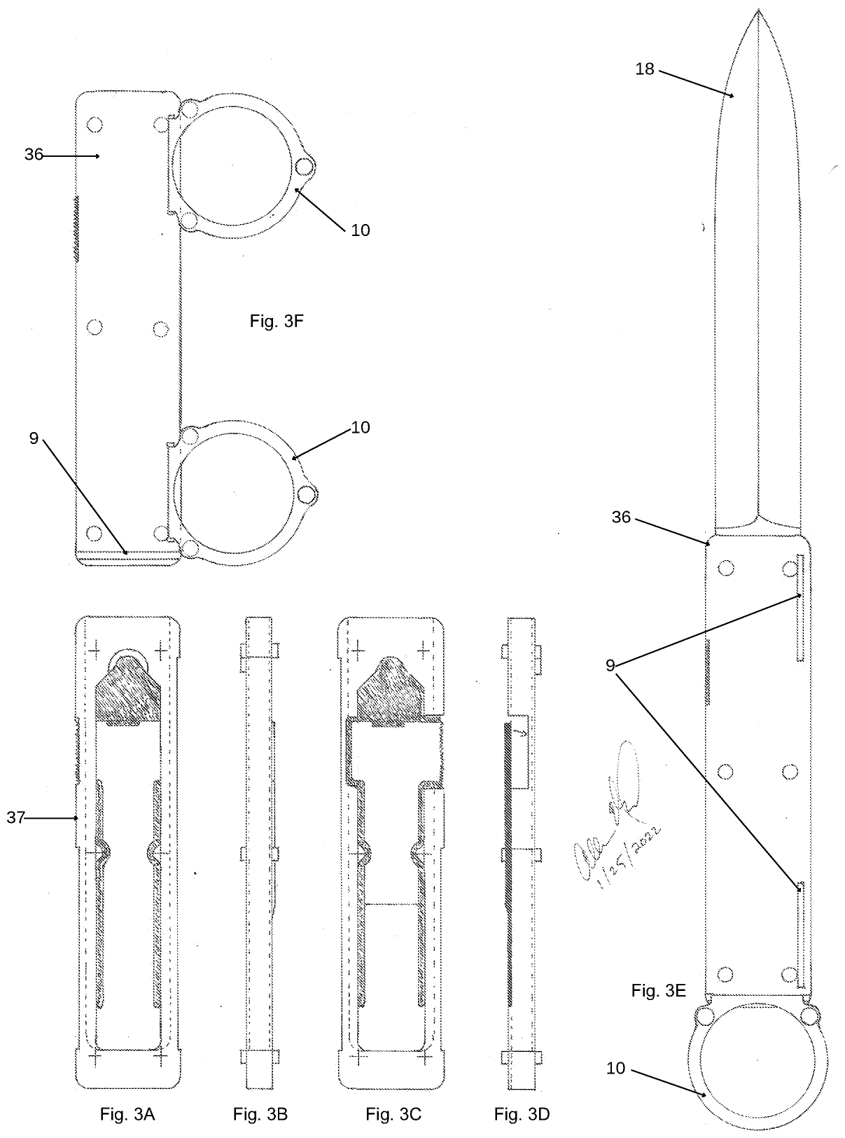

Referring to FIGS. 3A to 3F—Frame only with handle and ring The elements include 9. Rails that allow the ring to be located horizontally or vertically on the handle 10. Adjustable or removable ring—This feature protects the hand from slipping 4. Blade 5. Front handle 6. Frame.

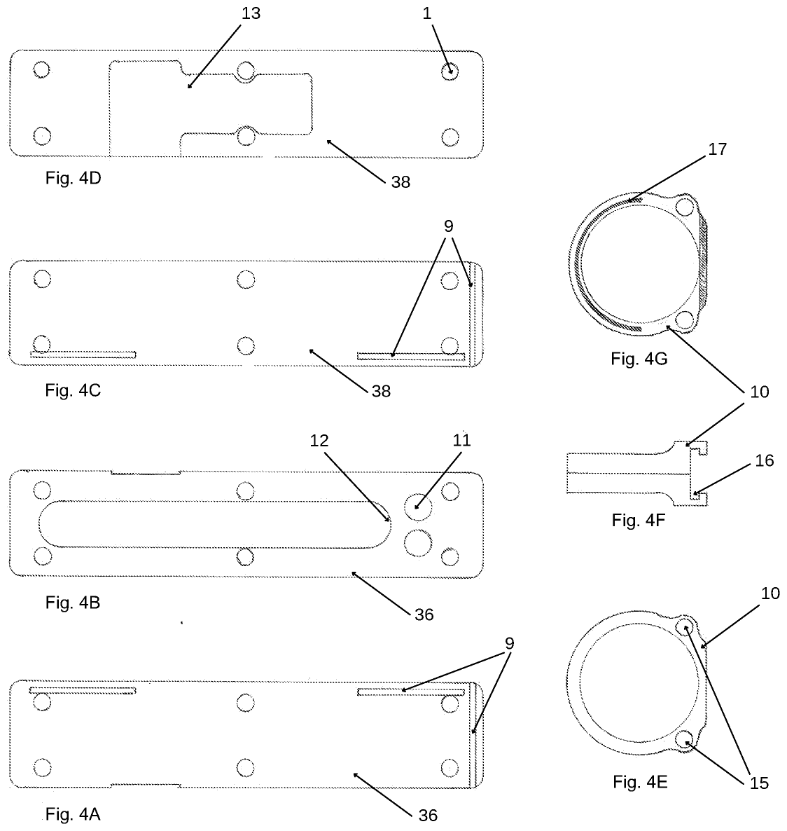

Referring to FIGS. 4A to 4G—Front and back handles and ring. The elements include 1. Taped holes to hold the handle material to the main frame. 9. Rails that allow the ring to be located horizontally or vertically on the handle. 10. Adjustable or removable ring—This feature protects the hand from slipping. 11. Magnets that hold the blade in the refracted position to prevent the blade from coming out. 12. Clearance for the stop pin (#5) to allow the blade movement in the extended position and act as a stop in the refracted position. 13. Relief for the thicker portion of the locking bar (#7). 15. Screws to keep the 2 halves of the ring together. 16. Notch to fit in rails (#9)—The ring is held together by the screws (#15) in a clamping motion. 17. View of the inside half of the ring—There is a positive bas relief which mates with its negative counterpart on the other half of the ring. This helps line up the 2 parts of the ring.

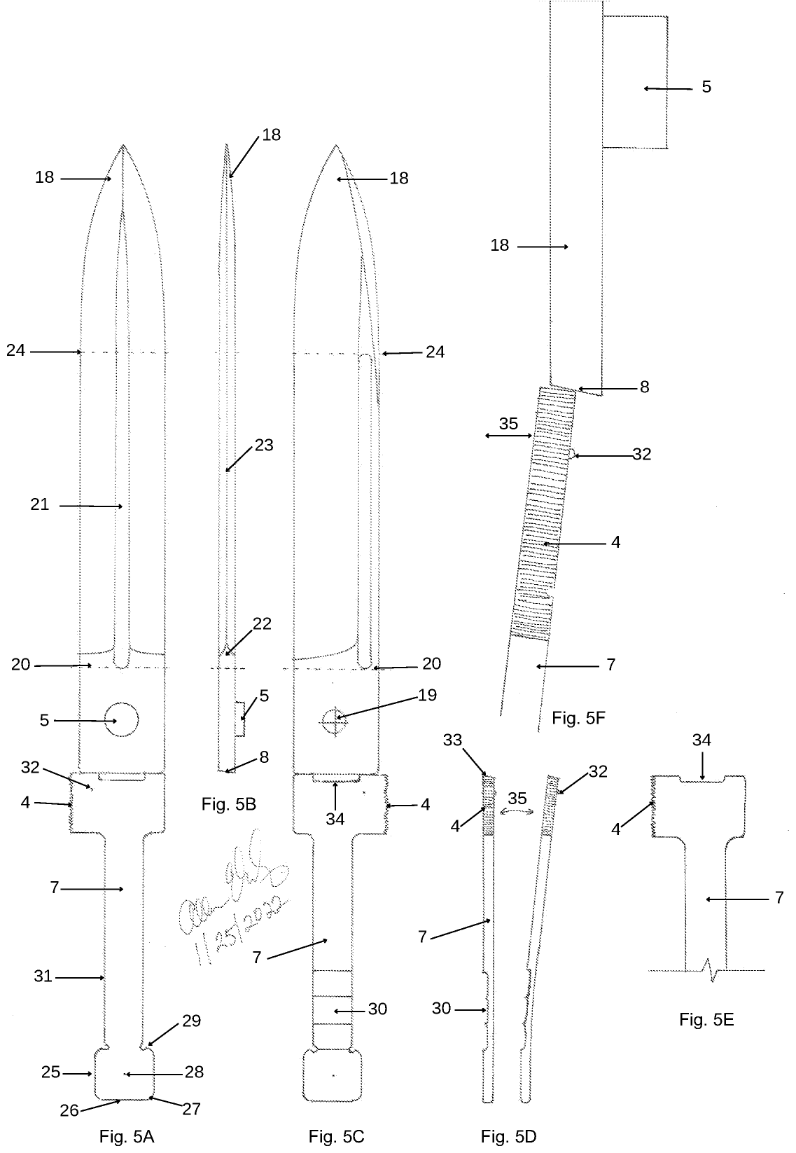

Referring to FIG. 5A to 5F—Blade, locking bar and interface. This is the description of how the lock engages the blade in the extended position. The designs show a separate locking bar. The Black Box can be made with an integral locking bar to the frame or a separate locking bar attached to the inside of one of the exterior handles. For simplicity I am showing the locking bar separated from both handle and frame. The elements include 1. Serrations on locking mechanism for fraction 2. Stop pin—The 0.3125″ diameter stop pin stops in the blade in the extended and retracted positions—The pin travels in a blind recessed pocket located on the inside of one of the exterior handles 8. Blade lock ramp—At the end of the blade there is a 9 degree taper that the locking bar engages and keeps the blade in the open/extended position—The taper prevents the locking bar from traveling all the way to the other end of the handle—It acts as a wedge. 18. Blade. 19. Blade is drilled and tapped with a 5-44 to secure the stop pin. 20. Front of the handle location at the forward most extended position. 21. A groove down the middle of the blade for aesthetics purpose. 22. The plunge of the grind of the cutting bevel. 23. The cutting edge ground to 0.0100″. 24. The line represents the handle location at the retracted position. Locking bar dimensions (subject to change). 25. 0.5″. 26. 0.625″. 27. 0.125″ Radius. 28. Drilled and tapped for a 5-44 screw. 29. 0.0625″ radius [25, 26, 27, 28 and 29 are the anchoring end of the locking bar—This fits in a pocket and held in by a screw—This prevents the locking bar from moving and anchors it at a specific location in the handle]. 30. 0.25″ grooves with radius corners to relieve material thickness so the spring can be bent. 31. 0.375″ width of the locking bar. 32. ball detent to prevent the locking bar from rubbing on the side of the blade and to reduce friction. 33. lock face—the lock face of the locking bar has a slight angle of 5 degrees to contact better on the blade surface. 34. countersunk surface to allow contact of the locking bar only at the opposing ends—The center of the locking bar does not make contact with the blade—This creates 2 points of contact. 35. the direction of movement of the locking bar—When at rest the locking bar is flexed upwards towards the blade—When the locking bar is straightened there is spring tension created.

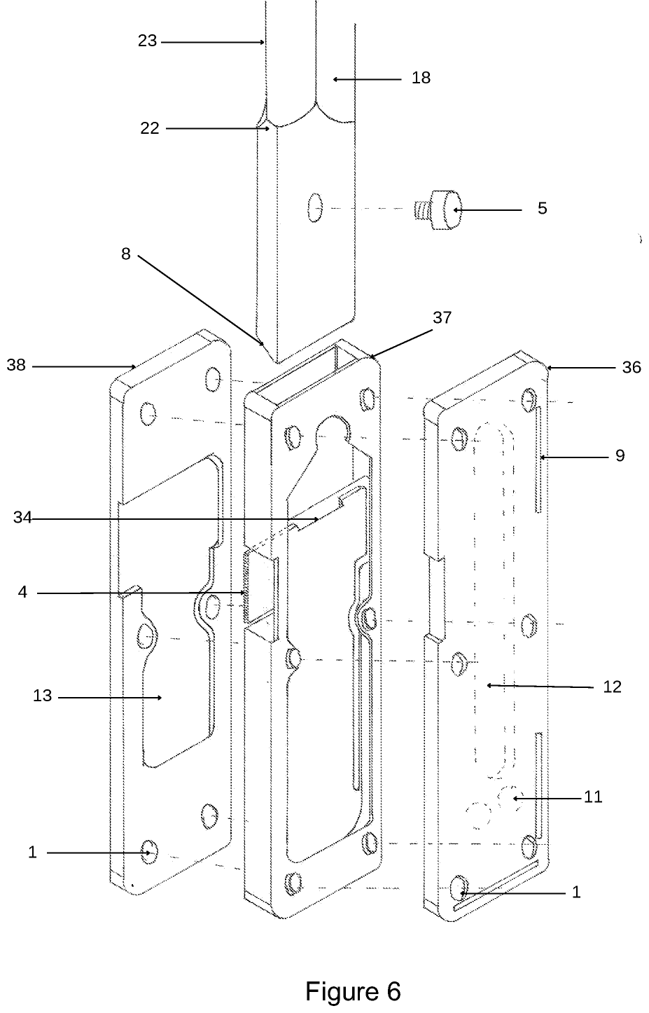

Referring to FIG. 6—Exploded view. In this diagram, it shows the exploded view of the Black Box and the relationship between the parts. The elements include 38. Back handle 1. Taped holes to hold the handle material to the main frame. 13. Relief in the handle to allow the thicker portion of the locking bar more space. 37. Frame. 4. Serrated texture to allow the thumb to depress the locking bar. 34. Countersunk surface that does not come in contact with the blade ramp (#8). 36. Front handle. 9. Rails for attaching ring/guards. 11. Countersunk blind holes for magnets to hold the blade in the retracted position—The magnets are flush with the surface of the material. 12. Clearance for the stop pin (#5) to allow the blade movement in the extended position and act as a stop in the retracted position. 18. Blade. 5. Stop pin—This stops the blade in the retracted and extended position. 8. Nine degrees angle on the back of the blade—It acts like a wedge with the locking bar, keeping the blade locked in the extended version until the user depresses the locking bar which in turns releases the blade into the handle. 22. Grind plunge. 23. Cutting edge

I claim:

1. A knife comprising:
An elongated frame defining a blade passage and having a forward opening at one end of the frame;
an elongated blade received in the frame and movable between an extended and a retracted position; and
the blade having a point at a first end and having a first blade portion extending from the frame when the blade is in the retracted position and a greater end position extended from the frame when the blade is in the extended position.
